(19) United States
(12) Patent Application Publication
(10) Pub. No.: US 2015/0035216 A1
(43) Pub. Date: Feb. 5, 2015

(54) ROLL UP CUTTING BOARD

(71) Applicant: Kerry Swendsen, Maple Lake, MN (US)

(72) Inventor: Kerry Swendsen, Maple Lake, MN (US)

(21) Appl. No.: 14/449,776

(22) Filed: Aug. 1, 2014

Related U.S. Application Data
(60) Provisional application No. 61/861,048, filed on Aug. 1, 2013.

(51) Int. Cl. A47J 47/00; A01M 31/00; A01K 99/00; G09F 23/00

(52) U.S. Cl. CPC A47J 47/005; G09F 23/00; A01M 31/00; A01K 99/00
USPC 269/289 R

(57) ABSTRACT

A rollup cutting board that provides instructions on how to butcher game is disclosed. The cutting board is sized for the animal to which it is to be used and provides instructions on properly cutting the animal. Further, the cutting board provides a durable, flexible cutting surface that is easy to clean and transport.

### RELATED APPLICATIONS

This application claims the benefit of U.S. Provisional Application No. 61/861,048, filed Aug. 1, 2013, which is hereby fully incorporated herein by reference.

### FIELD OF THE INVENTION

The present invention relates to a roll up cutting board that includes instructions on how to butcher or field dress game.

### SUMMARY OF THE INVENTION

The invention is a roll-up cutting board or mat that includes instructions on how to butcher game. The cutting board provides step-by-step instructions for field dressing wild game or for properly cutting the various parts of the animal. The preferred embodiment includes instructions on how to butcher deer, but the invention is not so limited. Other game such as fish, birds, and other mammals are contemplated. The present invention may not only include instructions for butchering game, but can also include instructions on sausage making

The cutting board is flexible enough to be rolled for storage. The preferred embodiment is 27 inches by 40 inches so as to allow for butchering a deer-sized animal as well as to provide instructions on butchering deer. The size of the cutting board will vary depending on the game for which instructions are provided. The cutting board does not have to be rectangular; it can be any shape that allows the presentation of instructions and provides sufficient surface area for the animal being butchered.

The cutting board is made of food-grade polyethylene, but can be made of any durable, flexible material. The material must be strong enough to prevent the blades of butcher knives from cutting through or puncturing the cutting board. The material should also be easy to clean and non-absorbent to prevent infiltration of bacteria and other harmful pathogens. In some embodiments the cutting board is formed entirely out of a resiliently pliable sheet of cut-resistant material. In some embodiments said material is taken from a group substantially consisting of polypropylene, polyurethane, acrylic, polycarbonate and steel.

The preferred embodiment of the invention is 1 millimeter thick, but may be thicker or thinner to provide less or more flexibility. The invention further contemplates a waterproof pocket built into the cutting board to hold recipes.

The instructions for butchering various parts of the animal (e.g., back strap or bottom round) are provided in separate sections of the cutting board. The instructions can also provide helpful tips for processing or storing the cuts of meat.

The invention further contemplates a means of keeping the cutting board in a rolled-up configuration. This can be done with tie-downs or snaps built into the cutting board. It could also include a band that slides over the rolled-up cutting board or a cylindrical container.

The above summary of the various representative embodiments of the invention is not intended to describe each illustrated embodiment or every implementation of the invention. Rather, the embodiments are chosen and described so that others skilled in the art can appreciate and understand the principles and practices of the invention.

### BRIEF DESCRIPTION OF THE DRAWINGS

FIG. 1 is a front perspective view of rollup cutting board according to an embodiment of the invention.

FIG. 2 is an example of a graphic used on a rollup cutting board according to an embodiment of the invention.

FIG. 3 is a blown up version of a section of instructions provided on a rollup cutting board according to an embodiment of the invention.

### DETAILED DESCRIPTION OF THE DRAWINGS

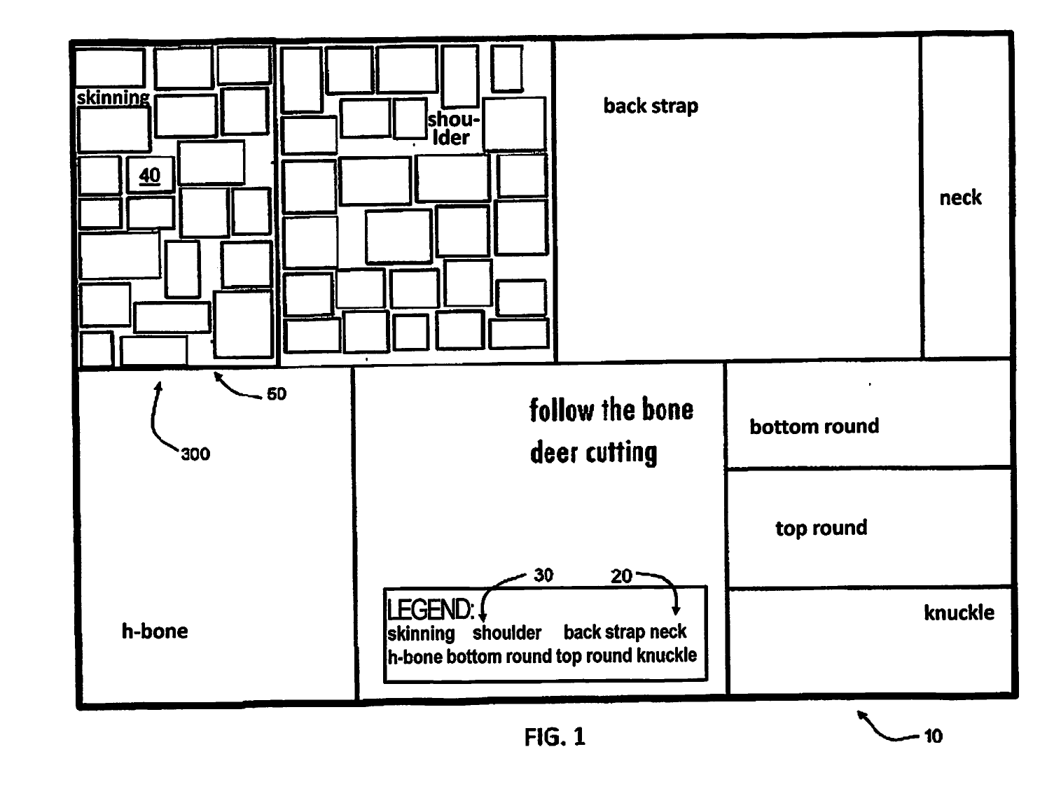

A rollup cutting board according to an embodiment is depicted generally in FIG. 1 with reference numeral 10. The rollup cutting board 10 includes instructions 40, 50 on how to butcher, field dress, or clean game. In the embodiment shown, the instructions are directed to butchering a deer. The instructions for butchering various parts of the animal (e.g., back strap or bottom round) are provided in separate sections 300 of the rollup cutting board. In the embodiment presented in FIG. 1, a legend 20 includes section titles 30 to direct the user to a specific part of the animal to be butchered, field dressed, or cleaned. The titles 30 can be color-coded to the background of each section 300 to allow for quick identification by the user.

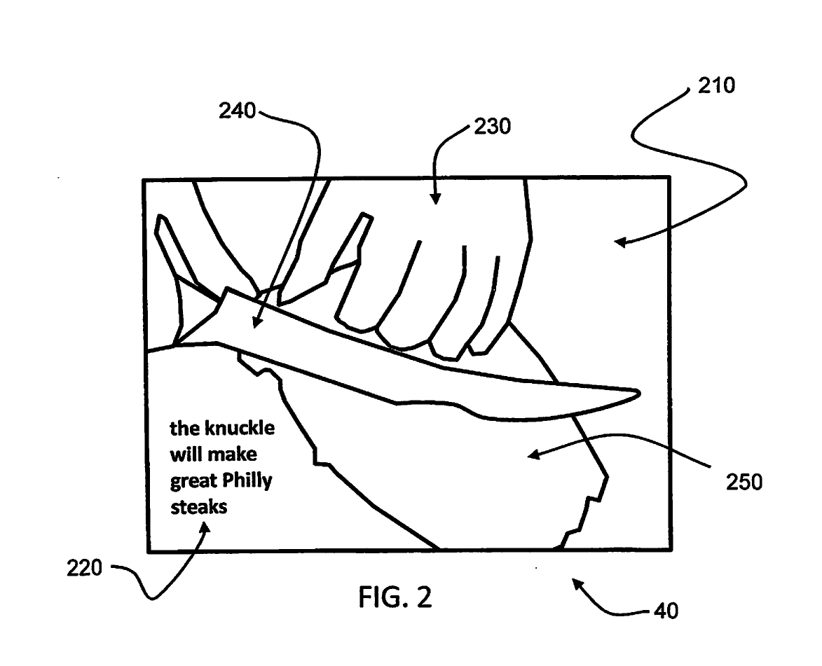

Referring to FIG. 2, a close-up of a graphic 40 presenting instructions is shown. The graphic 40 can be a drawing, photograph, or other means to visually present detailed instructions on how to butcher, field dress, or clean game. In this embodiment, the graphical image 210 illustrates the cutting of steaks from a deer knuckle. The instructions provide correct placement of the cutting implement 240 in relation to the user's hand 230 and the meat being butchered 250. The graphic 40 can also provide instructional text or points of interest 220 regarding the particular meat being butchered 250.

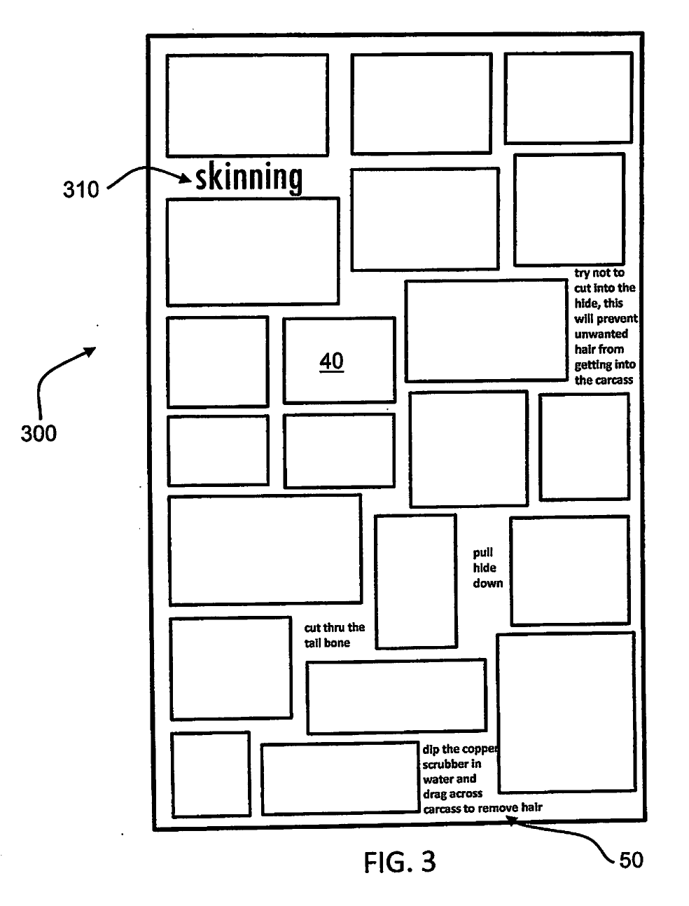

FIG. 3 presents a close-up of a section 300 according to an embodiment of the invention. Each of these sections 300 can be directed to a specific part of the animal being butchered. In this instance, the section 300 is directed to the skinning of a deer. Each section 300 is labeled 310 to allow a user to quickly find instruction on the animal part of interest. In addition to graphical representations 40, the sections can also present instructional text 50 between the graphical representations 40.

The embodiments above are intended to be illustrative and not limiting. Additional embodiments are within the claims. In addition, although embodiments of the invention have been described with reference to particular embodiments, those skilled in the art will recognize that changes can be made in form and detail without departing from the spirit and scope of the invention.

I claim:

1. A rollup cutting board comprising:
a sheet of flexible, cut-resistant material;
instructions for butchering an animal;
wherein the sheet of flexible, cut-resistant material is non-absorbent; and
wherein the rollup cutting board is sized to provide sufficient cutting surface for an animal being butchered.

2. The rollup cutting board of claim 1, wherein the sheet of flexible material, cut-resistant material comprises food-grade polyethylene.

3. The rollup cutting board of claim 1, wherein the instructions include graphics demonstrating the instructions.

4. The rollup cutting board of claim 1, wherein the instructions are printed directly on the sheet of flexible material, cut-resistant material.

5. The rollup cutting board of claim 2, wherein the sheet of flexible, cut-resistant material has a thickness of 0.75-1.5 millimeters.

6. The rollup cutting board of claim 4, wherein the instructions are presented for different parts of the animal in separate sections.

7. The rollup cutting board of claim 5, wherein the separate sections are color-coded to a legend provided in the instructions.

8. The rollup cutting board of claim 4, wherein the instructions presented are for butchering a deer.

9. The rollup cutting board of claim 5 further comprising:
means for keeping the rollup cutting board in a rolled-up configuration.

10. The rollup cutting board of claim 4, further comprising:
a waterproof pouch for storing recipes.

11. A rollup cutting board comprising:
a sheet of pliable, durable material;
instructions for field-dressing an animal;
wherein the sheet of pliable, durable material is non-absorbent; and
wherein the rollup cutting board is sized to provide sufficient cutting surface for an animal being field dressed.

12. The rollup cutting board of claim 11, wherein the instructions are printed directly on the sheet of pliable, durable material.

13. The rollup cutting board of claim 12, wherein the sheet of pliable, durable material comprises polyethylene, polypropylene, polyurethane, acrylic, polycarbonate or steel.

14. The rollup cutting board of claim 13, wherein the sheet of pliable, durable material has a thickness of approximately one millimeter.

15. The rollup cutting board of claim 13, wherein the separate sections are color-coded to a legend provided in the instructions.

16. The rollup cutting board of claim 15, wherein the instructions presented are for field dressing a deer.

17. A rollup fish cleaning mat comprising:
a sheet of flexible, cut-resistant material;
instructions for cleaning a fish;
wherein the sheet of flexible, cut-resistant material is non-absorbent; and
wherein the rollup fish cleaning mat is sized to provide sufficient cutting surface for an a fish being cleaned.

18. The rollup fish cleaning mat of claim 17, wherein the sheet of flexible material, cut-resistant material comprises food-grade polyethlylene.

19. The rollup fish cleaning mat of claim 18, wherein the instructions are printed directly on the sheet of flexible material, cut-resistant material.

20. The rollup fish cleaning mat of claim 18, further comprising:
a waterproof pouch for storing recipes.
